(19) United States
(12) Patent Application Publication
(10) Pub. No.: US 2014/0162115 A1
(43) Pub. Date: Jun. 12, 2014

(54) BATTERY AND METHOD FOR MANUFACTURING THE SAME

(71) Applicant: Takamasa Otomo, Susono-shi (JP)

(72) Inventor: Takamasa Otomo, Susono-shi (JP)

(21) Appl. No.: 13/395,507

(22) PCT Filed: May 25, 2011
(86) PCT No.: PCT/JP2011/061949

§ 371 Date: Mar. 12, 2012

(51) Int. Cl. H01M 2/02

(52) U.S. Cl. CPC H01M 2/0245
USPC 429/177; 29/623.1; 29/623.2

(57) ABSTRACT

A main object of the present invention is to provide a battery wherein a unit cell can be uniformly pressurized, and a method for manufacturing the same.

The present invention is a battery comprising: a unit cell which is provided with a stacked body comprising a cathode layer, an anode layer, and an electrolyte layer disposed between the cathode layer and the anode layer, and which is provided with a unit cell case accommodating the stacked body; and an exterior battery case which accommodates the unit cell, wherein a fluid capable of pressurizing the unit cell is filled in the outside of the unit cell case and the inside of the exterior battery case; and a portion to be sealed of the unit cell case is positioned outside the exterior battery case.

And the present invention is a method for manufacturing a battery comprising, in the mentioned order, the steps of: producing the unit cell; accommodating the unit cell into the exterior battery case in such a manner that a portion to be sealed of the unit cell case is disposed outside the exterior battery case; and injecting a fluid for pressurizing the unit cell to the outside of the unit cell case and the inside of the exterior battery case, with the portion to be sealed of the unit cell case open.

### TECHNICAL FIELD

The present invention relates to a battery and a method for manufacturing the same; and particularly relates to a battery wherein a unit cell is pressurized by using a fluid, and to a method for manufacturing the same.

### BACKGROUND ART

A Lithium-ion secondary battery (hereinafter sometimes referred to as a “lithium secondary battery”) has characteristics that it has a higher energy density and is operable at a high voltage compared to other secondary batteries. Therefore, it is used for information equipment such as a cellular phone, as a secondary battery which can be easily reduced in size and weight. And, in recent years, there has also been an increasing demand of the lithium-ion secondary battery to be used as a power source for large-scale apparatuses such as electric vehicles and hybrid vehicles.

A lithium-ion secondary battery comprises: a cathode layer; an anode layer; and an electrolyte layer disposed therebetween. And nonaqueous liquid or solid substances, for example, are known to be used as an electrolyte for the electrolyte layer. When a liquid electrolyte (hereinafter referred to as an “electrolytic solution”) is used, the electrolytic solution easily permeates inside the cathode layer and the anode layer. Therefore, the interface between an active material contained in the cathode layer or the anode layer, and the electrolytic solution is easily formed; and the performance of the battery is easily improved. However, since a widely-used electrolytic solution is flammable, it is necessary to mount a system to ensure safety. On the other hand, when a solid electrolyte, which is nonflammable (hereinafter referred to as a “solid electrolyte”), is used, the above system can be simplified. Accordingly, there has been proposed a lithium-ion secondary battery which is provided with a layer containing a nonflammable solid electrolyte (hereinafter, the layer being referred to as a “solid electrolyte layer”; and the battery being referred to as a “solid battery”).

As a technique related to such a battery, for example, Patent Document 1 discloses a lithium-ion secondary battery wherein in an assembled battery having an assembled battery case accommodated with a plurality of unit cells combined, the space outside a unit cell case and inside the assembled battery case is filled with at least one of a gas, liquid, or solid powder, or filled with a mixed substance thereof, thereby generating hydrostatic pressure in the assembled battery case, and using the hydrostatic pressure to pressurize the unit cells.

### CITATION LIST

### Patent Literatures

Patent Document 1: Japanese Patent Application Laid-Open No. 10-214638

### SUMMARY OF THE INVENTION

### Problems to be Solved by the Invention

According to the technique disclosed in Patent Document 1, since the hydrostatic pressure generated in the assembled battery case is used to pressurize the unit cell, it can be considered easy to uniformly pressurize the unit cell. However, even with the technique disclosed in Patent Document 1, there is a problem that it is difficult to pressurize a unit cell uniformly if a large amount of gas remains inside a unit cell case.

Accordingly, an object of the present invention is to provide a battery wherein a unit cell can be uniformly pressurized; and a method for manufacturing the same.

### Means for Solving the Problems

In order to solve the above problems, the present invention takes the following means. That is, a first aspect of the present invention is a battery comprising: a unit cell which is provided with a stacked body comprising a cathode layer, an anode layer, and an electrolyte layer disposed between the cathode layer and the anode layer, and which is provided with a unit cell case accommodating the stacked body; and an exterior battery case which accommodates the unit cell, wherein a fluid capable of pressurizing the unit cell is filled in the outside of the unit cell case and the inside of the exterior battery case; and a portion to be sealed of the unit cell case is positioned outside the exterior battery case.

A second aspect of the present invention is a method for manufacturing a battery comprising: a unit cell which is provided with a stacked body comprising a cathode layer, an anode layer, and an electrolyte layer disposed between the cathode layer and the anode layer, and which is provided with a unit cell case accommodating the stacked body; and an exterior battery case which accommodates the unit cell, wherein the method comprises the steps of: producing the unit cell; after producing the unit cell, accommodating the unit cell into the exterior battery case in such a manner that a portion to be sealed of the unit cell case is disposed outside the exterior battery case; and after accommodating the unit cell, injecting a fluid for pressurizing the unit cell to the outside of the unit cell case and the inside of the exterior battery case, with the portion to be sealed of the unit cell case open.

In the second aspect of the present invention, it is preferable to inject the fluid, in the injecting step, until the fluid pressure becomes the primary pressure and to comprise a pressure reducing step of reducing the pressure of the fluid for pressurizing the unit cell to below the primary pressure, after the injecting step.

### Effects of the Invention

In the battery according to the first aspect of the present invention, the portion to be sealed of the unit cell case is positioned outside the exterior battery case. Hence, when injecting the fluid for pressurizing the unit cell in the outside of the unit cell case and the inside of the exterior battery case, it is possible to discharge a gas remaining inside the unit cell case to the outside of the unit cell case and of the exterior battery case, thereby enabling reducing the gas remaining inside the unit cell case. By reducing the gas remaining inside the unit cell case, it is possible to uniformly pressurize the unit cell by using the fluid to be filled in the outside of the unit cell case. Therefore, according to the first aspect of the present invention, it is possible to provide a battery wherein a unit cell can be uniformly pressurized.

The second aspect of the present invention comprises the injecting step of injecting the fluid for pressurizing the unit cell, with the portion to be sealed of the unit cell case open, which portion is disposed outside the exterior battery case. By carrying out the injecting step with the portion to be sealed of the unit cell case open, it is possible to pressurize the unit cell case using the injected fluid and concurrently to discharge to the outside of the unit cell case, the gas remaining inside the unit cell case pressurized by the fluid; therefore, the gas remaining inside the unit cell case can be reduced. By reducing the gas remaining inside the unit cell case, the unit cell can be uniformly pressurized with the fluid to be filled in the outside of the unit cell case. Thus, according to the second aspect of the present invention, it is possible to provide a method for manufacturing a battery by which method a battery wherein a unit cell can be uniformly pressurized can be manufactured.

Further, in the second aspect of the present invention, by comprising, after the injecting step, the pressure reducing step of reducing the pressure of the fluid injected in the injecting step, it is possible to secure the fluid pressure necessary for pressurizing the unit cell and also to prevent an excessive pressure from being applied to the unit cell case and the exterior battery case. By preventing an excessive pressure from being applied, it becomes easy to inhibit damage to the unit cell case and to the exterior battery case; and by inhibiting damage to the unit cell case and to the exterior battery case, it becomes easy to uniformly pressurize the unit cell over a long period of time. Accordingly, with the configuration of comprising the pressure reducing step, it becomes easy to uniformly pressurize the unit cell over a long period of time, in addition to the above mentioned effects.

### BRIEF DESCRIPTION OF THE DRAWINGS

FIG. 1 is a cross-sectional view illustrating a battery 10 of the present invention;

FIG. 2 is a cross-sectional view illustrating a stacked body 1;

FIG. 3 is a flow chart illustrating a method for manufacturing a battery, of the present invention;

FIG. 4 is a cross-sectional view illustrating an injecting step;

FIG. 5 is a view illustrating a conventional method for manufacturing a battery.

### MODES FOR CARRYING OUT THE INVENTION

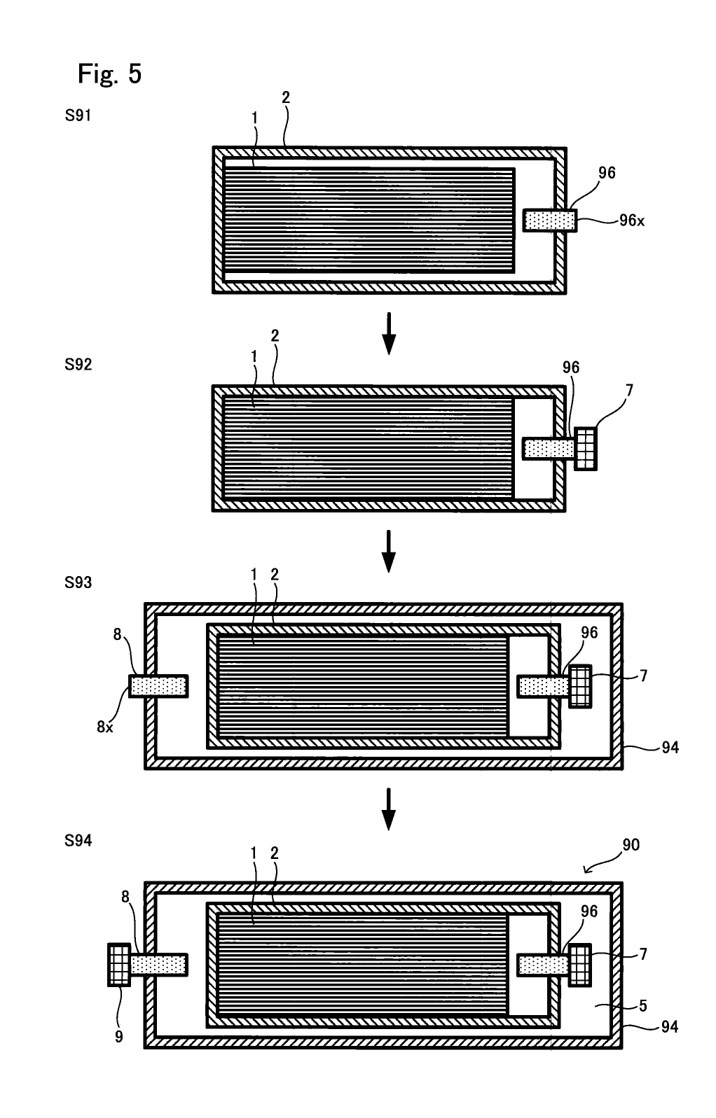

FIG. 5 is a view illustrating a conventional method for manufacturing a battery. As shown in FIG. 5, in a case of manufacturing a battery 90 having a configuration in which a unit cell is pressurized with a high-pressure fluid, conventionally, a stacked body 1 comprising a cathode layer, a solid electrolyte layer, and an anode layer is incorporated into a laminate film 2 (S91); the pressure inside the laminate film 2 is reduced and an outlet port 96x of a gas discharging passage 96 is sealed with a sealing member 7 (S92); thereafter, the laminate film 2 is incorporated into an exterior battery case 94 (S93); and a fluid 5 is injected into the exterior battery case 94, after which an inlet port 8x of a fluid injecting passage 8 is sealed with a sealing member 9 (S94). However, in the conventional manufacturing steps of S91 through S94, S92 as a step of reducing pressure and S94 as a step of injecting the fluid 5 are separately carried out; thus the number of steps tends to increase. Also, in the configuration of carrying out S94 after carrying out S92, when there is insufficient pressure reduction in S92, even if the fluid 5 is filled in S94, the gas remaining inside the laminate film 2 reacts thereagainst; therefore it is difficult to uniformly pressurize the stacked body 1 accommodated into the closed container 94.

The inventor conducted an intensive study to improve the current situation, and as a result, found that by disposing outside the exterior battery case 4, the outlet port of the gas discharging passage through which the gas discharged from inside the laminate film 2 to the outside passes, it is possible to carry out reducing the pressure inside the laminate film 2 and injecting the fluid 5 into the exterior battery case 4 concurrently. And the inventor found that when carrying out reducing the pressure inside the laminate film 2 and injecting the fluid 5 concurrently, first of all, the fluid in an amount that enables providing more pressure necessary to pressurize the cell, is injected to the outside of the laminate film 2 and the inside of the exterior battery case 4, after which the outlet port of the gas discharging passage disposed outside the exterior battery case 4 is closed; and the fluid pressure inside the exterior battery case 4 is reduced, after which the fluid injecting port is closed; thereby, a volume energy density and a weight energy density can be increased and the stacked body 1 accommodated into the laminate film 2 can be uniformly pressurized. The present invention was made based on the above findings.

Hereinafter, a case in which the battery of the present invention is a lithium-ion secondary battery using a solid electrolyte layer (i.e. a solid battery) will be explained with reference to the figures. It should be noted that the below described modes are examples of the present invention; and the present invention is not limited to the below described modes.

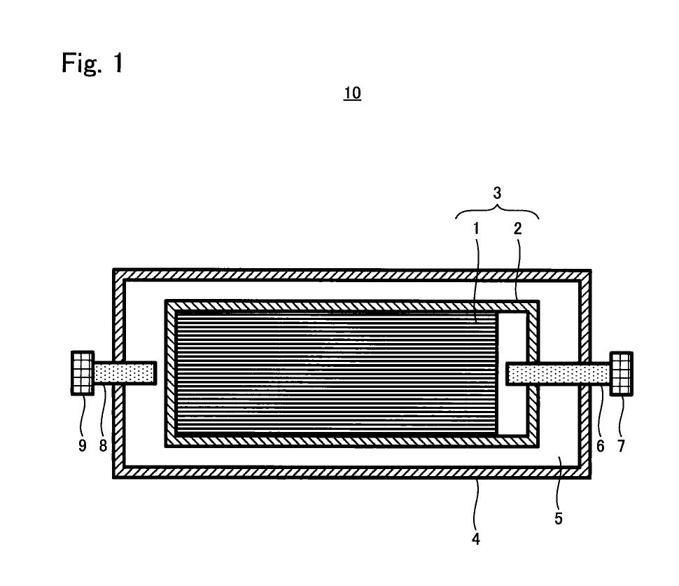

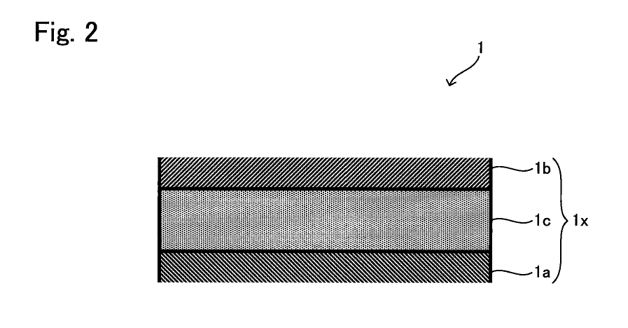

FIG. 1 is a cross-sectional view illustrating the battery 10 of the present invention; and FIG. 2 is a cross-sectional view illustrating the stacked body 1 provided to the battery 10. FIG. 2 is an enlarged view of a part of the stacked body 1. As shown in FIG. 1, the battery 10 comprises: a unit cell 3 provided with the stacked body 1 and with the unit cell case 2 which accommodates the stacked body; and the exterior battery case 4 accommodating the unit cell 3, wherein the fluid 5 is filled in the outside of the unit cell case 2 and the inside of the exterior battery case 4. The unit cell case 2 is connected with the gas discharging passage 6 which is used at a time of discharging the gas inside the unit cell case 2 to the outside; and one end of the gas discharging passage 6, the end being the portion to be sealed of the unit cell case 2, is positioned outside the exterior battery case 4. One end of the gas discharging passage 6 positioned outside the exterior battery case 4 (hereinafter referred to as an “outlet port of the gas discharging passage 6”) is sealed by the sealing member 7. Further, the exterior battery case 4 is connected with the fluid injecting passage 8 which is used at a time of injecting the fluid 5 to the outside of the unit cell case 2 and the inside of the exterior battery case 4; and one end of the fluid injecting passage 8 positioned outside the exterior batter case 4 (hereinafter referred to as an “inlet port of the fluid injecting passage 8”) is sealed by the sealing member 9.

As shown in FIG. 2, the stacked body 1 is provided with an electrode body 1x comprising a cathode layer 1a, an anode layer 1b, and a solid electrolyte layer 1c sandwiched by the cathode layer 1a and the anode layer 1b. The cathode layer 1a is connected to a cathode terminal (not shown) via a cathode current collector (not shown); and the anode layer 1b is connected to an anode terminal (not shown) via an anode current collector (not shown). One end of the cathode terminal and one end the anode terminal are respectively positioned outside the exterior battery case 4. The stacked body 1 comprises one or more electrode bodies 1x; and when two or more electrode bodies 1x, 1x, . . . are provided to the stacked body 1, the adjacent electrode bodies 1x, 1x are electrically connected in series or in parallel.

The battery 10 configured in this manner can be manufactured, for example, through the following steps. In manufacturing the battery 10, first of all, the solid electrolyte layer 1c is disposed between the cathode layer 1a and the anode layer 1b, to produce the stacked body 1. After that, the stacked body 1 is encased in the unit cell case 2 (hereinafter sometimes referred to as a “laminate film 2”) connected with the gas discharging passage 6, in such a manner that the end portions of the cathode terminal and the anode terminal are respectively positioned outside the laminate film 2; and the outer edges of the laminate film 2 are joined together by a known method such as thermal adhesion, to thereby produce the unit cell 3. Subsequently, the unit cell 3 is accommodated into the exterior battery case 4 connected with the fluid injecting passage 8, in such a manner that the end portions of the cathode terminal and the anode terminal, and the outlet port of the gas discharging passage 6 are disposed outside the exterior battery case 4. After accommodating the unit cell 3 into the exterior battery case 4 in this manner, the fluid 5 is filled in the outside of the laminate film 2 and the inside of the exterior battery case 4, with the outlet port of the gas discharging passage 6 open. By injecting the fluid 5 with the outlet port of the gas discharging passage 6 open, it is possible to pressurize the laminate film 2 with the fluid 5, and to discharge the gas remaining inside the laminate film 2 from the outlet port of the gas discharging passage 6 to the outside of the exterior battery case 4. After discharging the gas remaining inside the laminate film 2 to the outside of the exterior battery case 4 in this manner, the outlet port of the gas discharging passage 6 is sealed with the sealing member 7. After that, the pressure of the fluid 5 is adjusted to the pressure suitable for pressurizing the unit cell 2, and the inlet port of the fluid injecting passage 8 is sealed with the sealing member 9. The battery 10 can be manufactured, for example through the above steps. It should be noted that in the battery 10, the stacked body 1 may be in a sheet form wherein a sheet-like cathode layer 1a, solid electrolyte layer 1c and anode layer 1b are laminated; and that it may also be in a cylindrical form wherein a sheet-like cathode layer 1a, solid electrolyte layer 1c and anode layer 1b are laminated and then wound up cylindrically.

According to the battery 10, in which the outlet port of the gas discharging passage 6 is positioned outside the exterior battery case 4, the outlet port of the gas discharging passage 6 is kept open at a time of injecting the fluid 5 to the outside of the laminate film 2 and the inside of the exterior battery case 4, thereby enabling easily pressurizing the laminate film 2 using the fluid 5. By having the laminate film 2 pressurized by the fluid 5, the gas remaining inside the laminate film 2 can be discharged to the outside of the exterior battery case 4. That is, it is possible to carry out reducing the pressure inside the laminate film 2 and injecting the fluid 5 concurrently. And by sealing the outlet port of the gas discharging passage 6 before sealing the inlet port of the fluid injecting passage 8, it is possible to reduce the gas inside the laminate film 2 (to reduce the pressure inside the laminate film 2) while preventing the gas and the like existing outside the exterior battery case 4 from flowing inside the laminate film 2. By reducing the pressure inside the laminate film 2, it becomes possible to uniformly pressurize the unit cell 3 with the fluid 5 filled in the outside of the laminate film 2 and the inside of the exterior battery case 4. Thus, according to the present invention, it is possible to provide the battery 10, wherein the unit cell 3 can be uniformly pressurized.

In the battery 10, a known cathode active material that can be contained in a cathode layer of a lithium-ion secondary battery may be adequately used as the cathode active material to be contained in the cathode layer 1a. Examples of such a cathode active material may include layered compounds such as lithium cobalt oxide (LiCoO₂). Further, a known solid electrolyte that can be contained in a cathode layer of a lithium-ion secondary battery may be adequately contained in the cathode layer 1a. Examples of such a solid electrolyte may not only include oxide solid electrolytes such as Li₃PO₄, but also include Li₃PS₄ and a sulfide solid electrolyte produced by mixing Li₂S and P₂S₅ so that the ratio becomes Li₂S: P₂S₅=50:50 to 100:0 (for example, a sulfide solid electrolyte produced by mixing Li₂S and P₂S₅ at a mole ratio of Li₂S: P₂S₅=75:25). In addition, a binder for binding a cathode active material and solid electrolyte, and an electrically conductive material for improving the electrical conductivity may also be contained in the cathode layer 1a. Examples of the binder that can be contained in the cathode layer 1a may include butylene rubber: and examples of the electrically conductive material that can be contained in the cathode layer 1a may include carbon black. Further, when producing the cathode layer 1a, a known solvent which is usable in preparing a slurry used at a time of producing a cathode layer of a lithium-ion secondary battery may be adequately employed. Examples of such a solvent may include heptan.

Further, as for the anode active material to be contained in the anode layer 1b, a known anode active material that can be contained in an anode layer of a lithium-ion secondary battery may be adequately employed. Examples of such an anode active material may include graphite. A solid electrolyte may be contained in the anode layer 1b; and a known solid electrolyte that can be contained in an anode layer of a lithium-ion secondary battery may be adequately contained therein. Examples of such a solid electrolyte may include the above described solid electrolytes that can be contained in the cathode layer 1a. In addition, a binder for binding an anode active material and solid electrolyte, and an electrically conductive material for improving the electrical conductivity may also be contained in the anode layer 1b. Examples of the binder and electrically conductive material that can be contained in the anode layer 1b may include the above described binders and electrically conductive materials that can be contained in the cathode layer 1a. And, when producing the anode layer 1b, the above described solvent and the like usable at a time of producing the cathode layer 1a may be adequately employed.

Furthermore, a solid electrolyte to be contained in the solid electrolyte layer is may be, for example, the above described solid electrolyte that can be contained in the cathode layer 1a. And, when producing the solid electrolyte layer 1c, the above described solvent and the like usable at a time of producing the cathode layer 1a may be adequately employed.

Moreover, the cathode current collector and anode current collector, and the cathode terminal and anode terminal may be constituted by a known electrically conductive material usable as a cathode current collector and anode current collector, and a cathode terminal and anode terminal of a lithium-ion secondary battery. Examples of such an electrically conductive material may include a metallic material containing one or more elements selected from a group consisting of Cu, Ni, Al, V, Au, Pt, Mg, Fe, Ti, Co, Cr, Zn, Ge, and In.

As for the unit cell case 2 (laminate film 2), a film which can endure the environment at a time of using a lithium-ion secondary battery; which does not allow a gas and/or liquid to permeate thereinto; and which can be sealed, may be used without special restrictions. Examples of a constituent material of such a film may include: resin films of polyethylene, polyvinyl fluoride, polyvinylidene chloride; and a metal vapor-deposited film, in which metal such as aluminum is vapor-deposited onto the surface of these resin films.

As for the exterior battery case 4, a constituent material thereof is not particularly restricted as long as it can endure the environment in which to operate the battery 10 and can endure the pressure of the fluid 5. The exterior battery case 4 may be made of metal such as aluminum and stainless steel.

As for the fluid 5, a nonflammable gas represented by carbon dioxide and the like; and an inert gas or the like represented by helium, nitrogen, argon, and the like may be employed. In addition to these, dry air may be used as the fluid 5. However, in view, for example, of easily enhancing the safety of the battery, it is preferable to use the above mentioned nonflammable gas and inert gas. In the battery 10, the pressure of the fluid 5 to pressurize the unit cell 3 may be, for example, 1 atmosphere or more and 200 atmospheres or less.

As for the gas discharging passage 6 and the fluid injecting passage 8, a constituent material thereof is not particularly restricted as long as it can endure the pressure of the fluid 5. For example, a known tube and the like formed of resin and reinforced by embedding a woven metallic wire therein, may be used as the gas discharging passage 6 and the fluid injecting passage 8.

As for the sealing material 7, a known substance may be adequately used, the substance being capable of blocking the outlet port of the gas discharging passage 6 so as to prevent the gas and the like existing outside the exterior battery case 4 from flowing in the laminate film 2. Examples of such a substance may include a known metal foil represented by an aluminum foil, and include a thermosetting resin such as epoxy resin.

As for the sealing material 9, a known substance may be adequately used, the substance being capable of blocking the inlet port of the fluid injecting passage 8 so as to prevent the fluid 5 filled inside the exterior battery case 4 from escaping to the outside of the exterior battery case 4. Examples of such a substance may include a known metal foil represented by an aluminum foil, and include a thermosetting resin such as an epoxy resin.

In the above descriptions of the battery 10, a gas is given as an example of the fluid 5; however, the fluid 5 of the present invention is not limited to a gas. The fluid 5 may be a known liquid; and a solid may also be used together with a gas and a liquid.

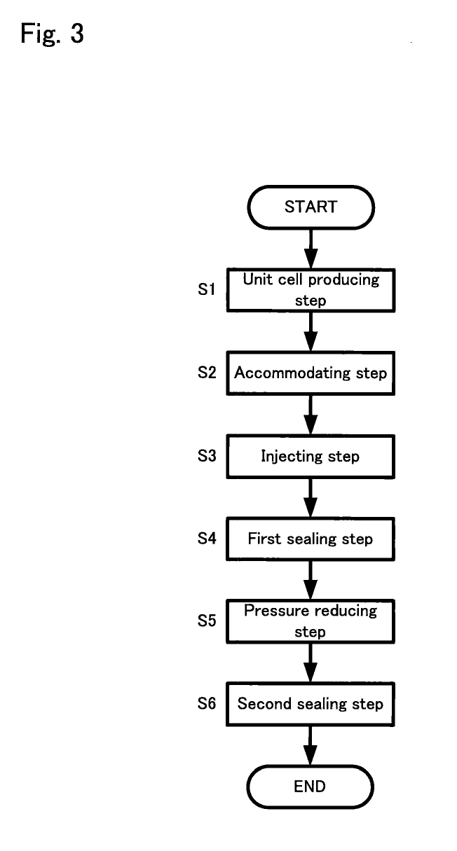

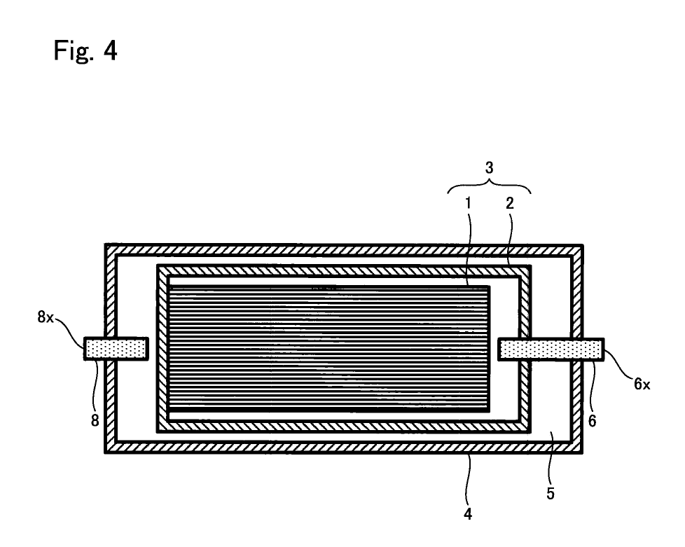

FIG. 3 is a flow chart illustrating the method for manufacturing a battery, of the present invention; FIG. 4 is a cross-sectional view illustrating an injecting step. Hereinafter, a case will be described in which the battery 10 is manufactured by the method for manufacturing a battery, of the present invention, with reference to FIGS. 1 to 4.

As shown in FIG. 3, the method for manufacturing a battery, of the present invention comprises: a unit cell producing step (S1); an accommodating step (S2); an injecting step (S3); a first sealing step (S4); a pressure reducing step (S5); and a second sealing step (S6). The battery 10 can be manufactured through these steps.

The unit cell producing step (hereinafter referred to as “S1”) is a step of producing the unit cell 3. S1 can be broadly divided into a step of producing the stacked body 1 and a step of accommodating the stacked body 1 into the laminate film 2 which is connected with the gas discharging passage 6.

In producing the stacked body 1, for example a cathode composition produced by dispersing at least a cathode active material and a solid electrolyte in a solvent is applied onto the surface of the cathode current collector, through which process the cathode layer 1a is formed on the surface of the cathode current collector. Also, an anode composition produced by dispersing an anode active material and a solid electrolyte in a solvent is applied onto the surface of the anode current collector, through which process the anode layer 1b is formed on the surface of the anode current collector. Then, an electrolyte composition produced by dispersing a solid electrolyte in a solvent is, for example, applied onto the surface of the cathode layer 1a, through which process the solid electrolyte layer 1c is formed; thereafter, the anode layer 1b formed on the surface of the anode current collector is disposed on the solid electrolyte layer 1c formed on the surface of the cathode layer 1a, in a manner sandwiching the solid electrolyte layer 1c by the cathode layer 1a and the anode layer 1b. After that, compressive force is applied to both end sides of a stack of the anode current collector, anode layer 1b, solid electrolyte 1c, cathode layer 1a, and cathode current collector, in a stacking direction (a thickness direction) thereof; thereby the stacked body 1 is produced. In a case when the stacked body 1 is in a cylindrical form, for example after applying compressive force to both end sides of the stack in the thickness direction thereof, the stack is wound up in a cylindrical manner to form a cylindrical body; and then, the end faces of the cylindrical body are joined together, through which process the stacked body 1 having a cylindrical form can be produced.

After producing the stacked body 1 in this way, the stacked body 1 is wrapped with the laminate film 2 connected with the gas discharging passage 6, in a manner not accommodating the entire end portion of the anode current collector connected to the anode terminal, and the entire end portion of the cathode current collector connected to the cathode terminal. Herein, the gas discharging passage 6 can be bonded to the laminate film 2 by using a known adhesive material or the like. After wrapping the stacked body 1 with the laminate film 2, for example the laminate film 2 (outer edges of the laminate film 2) located around the stacked body 1 is heated for thermal adhesion, through which process the unit cell 3 comprising the stacked body 1 and the laminate film 2 wrapping the stacked body 1 can be produced.

The accommodating step (hereinafter referred to as “S2”) is a step of accommodating the unit cell 3 produced in S1 into the exterior battery case 4 in such a manner that the outlet port 6x of the gas discharging passage 6, the outlet port corresponding to the portion to be sealed of the unit cell case 2, is disposed outside the exterior case 4. In a case when the exterior battery case 4 comprises: a housing which has an opening and which is connected with the fluid injecting passage 8; and a lid which closes the opening of the housing, S2 may include the below described steps. First of all, the unit cell 3 is incorporated into the housing through the opening of the housing, in such a manner that the cathode terminal whose end portion is positioned outside the housing is connected with the cathode current collector, and that the anode terminal whose end portion is positioned outside the housing is connected with the anode current collector. After that, the gas discharging passage 6 is passed through a hole for the gas discharging passage 6 which hole is provided to the lid, in such a manner that the outlet port 6x of the gas discharging passage 6 is disposed outside the exterior battery case 4; and the opening of the housing is closed with the lid. After closing the opening of the housing with the lid in this way, the housing and the lid are joined together to close the hole for the cathode terminal and the hole for the anode terminal which holes are provided to the housing, and the hole for the gas discharging passage 6 which hole is provided to the lid. With this configuration of S2 for example, the unit cell 3 can be accommodated into the exterior battery case 4.

The injecting step (hereinafter sometimes referred to as “S3”) is a step of injecting the fluid 5 from the inlet port 8x of the fluid injecting passage 8 to the outside of the laminate film 2 and the inside of the exterior battery case 4, with the outlet port 6x of the gas discharging passage 6 open, after the above S2. FIG. 4 shows a cross section of the unit cell 3, exterior battery case 4, gas discharging passage 6, and fluid injecting passage 8, at a time of carrying out S3. As shown in FIG. 4, S3 is carried out with the outlet port 6x of the gas discharging passage 6 open. With this configuration of S3, it is possible to apply force evenly all the way from the outside of the laminate film 2 to the inside by means of the fluid 5; and to discharge the gas existing inside the laminate film 2 from the outlet port 6x of the gas discharging passage 6 to the outside of the exterior battery case 4. In the method for manufacturing a battery, of the present invention, the pressure of the fluid 5 injected in S3 is adjusted, thereby enabling adjusting the amount of gas discharged from the outlet port 6x of the gas discharging passage 6. More specifically, raising the pressure of the fluid 5 injected in S3 enables increase in the amount of gas discharged from the outlet port 6x of the gas discharging passage 6, namely enables decrease in the amount of gas remaining inside the laminate film 2.

The first sealing step (hereinafter sometimes referred to as “S4”) is a step of sealing the outlet port 6x of the gas discharging passage 6 with the sealing member 7, after starting the above S3. A method for sealing the outlet port 6x of the gas discharging passage 6 is not particularly restricted; a known method may be employed. By sealing the outlet port 6x of the gas discharging passage 6, it is possible to keep the gas remaining inside the laminate film 2 discharged to the outside of the exterior battery case 4 (to keep the pressure inside the laminate film 2 reduced).

The pressure reducing step (hereinafter sometimes referred to as “S5”) is a step of reducing the pressure of the fluid 5 injected to the outside of the laminate film 2 and the inside of the exterior battery case 4, after the above S4. As stated above, raising the pressure of the fluid 5 injected into the exterior battery case 4 in the above S3 enables decrease in the amount of gas existing inside the laminate film 2. In the method for manufacturing a battery, of the present invention, it is possible to keep the pressure of the fluid 5 injected in the above S3 as it is; and in order to keep the pressure of the fluid 5 as it is, the laminate film 2 and the exterior battery case 4 are required to have a pressure resisting performance to resist the pressure. In order to enhance the pressure resisting performance of the laminate film 2 and the exterior battery case 4, it is necessary to take countermeasures such as making a thickness thereof large; and such countermeasures tend to cause a volume energy density and a weight energy density of a battery to decrease. In order to make a battery have an increased volume energy density and weight energy density, it is effective to make the thickness of the laminate film 2 and the exterior battery case 4 small. And in order to be able to uniformly pressurize the unit cell 3 over a long period of time even when the thickness of the laminate film 2 and the exterior battery case 4 is small, it is effective to reduce, after the above S4, the pressure of the fluid 5 injected in the above S3. From these viewpoints, in the method for manufacturing a battery, of the present invention shown in FIG. 3, S5 is carried out after the above S4. SS may be, for example, a step of: stopping supply of the fluid 5 to the outside of the laminate film 2 and the inside of the exterior battery case 4; thereafter, keeping the inlet port 8x of the fluid injecting passage 8 open over a predetermined time period, to discharge to the outside of the exterior battery case 4, a part of the fluid 5 injected to the outside of the laminate film 2 and the inside of the exterior battery case 4; and thereby reducing the pressure of the fluid 5.

The second sealing step (hereinafter sometimes referred to as “S6”) is a step of sealing the inlet port 8x of the fluid injecting passage 8 with the sealing member 9, after the above S5. A method for sealing the inlet port 8x of the fluid injecting passage 8 is not particularly limited; a known method may be employed. By sealing the inlet port 8x of the fluid injecting passage 8, it is possible to keep the unit cell 3 uniformly pressurized by the fluid 5.

As described above, according to the method for manufacturing a battery, of the present invention, the method comprising the steps S1. through S6, it is possible to manufacture the battery 10 wherein the unit cell 3 can be uniformly pressurized. Thus, according to the present invention, it is possible to provide a method for manufacturing a battery by which method it is possible to manufacture a battery wherein a unit cell can be uniformly pressurized.

In the above descriptions related to the method for manufacturing a battery, of the present invention, a configuration of comprising the pressure reducing step after S3 (more specifically, after S4) has been shown as an example, to which configuration the method for manufacturing a battery, of the present invention is not limited. However, in order to be able to improve the volume energy density and the weight energy density and to uniformly pressurize the unit cell, it is preferable to comprise the pressure reducing step after the injecting step (for example, after the first sealing step).

Further, in the above descriptions related to the method for manufacturing a battery, of the present invention, a configuration of comprising the second sealing step of sealing the inlet port 8x of the fluid injecting passage 8 with the sealing member 9, after the first sealing step of sealing the outlet port 6x of the gas discharging passage 6 with the sealing member 7, has been shown as an example, to which configuration the method for manufacturing a battery, of the present invention is not limited. However, in order to prevent the gas or the like existing outside the exterior battery case from flowing into the unit cell case, and to reduce the amount of gas remaining inside the unit cell case, it is preferable to comprise: the first sealing step of sealing the portion to be sealed of the unit cell case, after starting the injecting step; and the second sealing step of sealing the assembled battery case, after the first sealing step.

In the above descriptions related to the present invention, a case in which the present invention is applied to a lithium-ion secondary battery and a manufacturing method thereof, has been shown as an example, to which the present invention is not limited. The battery of the present invention may be configured in a manner that ion other than lithium-ion moves between the cathode layer and the anode layer; and the method for manufacturing a battery, of the present invention may be a method for manufacturing a battery where ion other than lithium-ion moves. Examples of such ion may be sodium ion, potassium ion, magnesium ion, and calcium ion. In a case of the configuration in which ion other than lithium-ion moves, a cathode active material, a solid electrolyte, and an anode active material may be adequately selected according to the moving ion.

Further, in the above descriptions related to the present invention, a case in which the present invention is applied to a solid battery comprising a solid electrolyte layer, and a manufacturing method thereof has been shown as an example, to which the present invention is not limited. The battery of the present invention may be a battery comprising an electrolyte layer using an electrolytic solution; and the method for manufacturing a battery, of the present invention may be a method for manufacturing a battery comprising an electrolyte layer using an electrolytic solution. However, in the solid battery, there is a greater necessity to uniformly pressurize a unit cell in order to enhance the performance of the battery, than in the battery comprising an electrolyte layer using an electrolytic solution. Therefore, in view of, for example, easily providing a battery having an enhanced performance, and a manufacturing method thereof, the present invention is preferably applied to a solid battery, and a manufacturing method thereof.

Furthermore, in the above descriptions related to the present invention, a case in which the present invention is applied to a secondary battery that can be charged and discharged and a manufacturing method thereof, to which the present invention is not limited. The battery of the present invention may be a primary battery; and the method for manufacturing a battery, of the present invention may be a method for manufacturing a primary battery.

### DESCRIPTION OF THE REFERENCE NUMERALS

1 stacked body

1a cathode layer

1b anode layer

1c solid electrolyte layer (electrolyte layer)

1x electrode body

2 laminate film (unit cell case)

3 unit cell

4, 94 exterior battery case

5 fluid

6, 96 gas discharging passage

6x, 96x outlet port (portion to be sealed of unit cell case)

7, 9 sealing member

8 fluid injecting passage

8x inlet port

10, 90 battery

1. A battery comprising:
a unit cell which is provided with a stacked body comprising a cathode layer, an anode layer, and an electrolyte layer disposed between the cathode layer and the anode layer, and which is provided with a unit cell case accommodating the stacked body; and
an exterior battery case which accommodates the unit cell,
wherein a fluid capable of pressurizing the unit cell is filled in the outside of the unit cell case and the inside of the exterior battery case; and
a portion to be sealed of the unit cell case is positioned outside the exterior battery case.

2. A method for manufacturing a battery comprising: a unit cell which is provided with a stacked body comprising a cathode layer, an anode layer, and an electrolyte layer disposed between the cathode layer and the anode layer, and which is provided with a unit cell case accommodating the stacked body; and an exterior battery case which accommodates the unit cell,
wherein the method comprises the steps of:
producing the unit cell;
after producing the unit cell, accommodating the unit cell into the exterior battery case in such a manner that a portion to be sealed of the unit cell case is disposed outside the exterior battery case; and
after accommodating the unit cell, injecting a fluid for pressurizing the unit cell to the outside of the unit cell case and the inside of the exterior battery case, with the portion to be sealed of the unit cell case open.

3. The method for manufacturing a battery according to claim 2, wherein in the injecting step, the fluid is injected until the fluid pressure becomes the primary pressure; and
the method comprises a pressure reducing step of reducing the pressure of the fluid for pressurizing the unit cell to below the primary pressure, after the injecting step.
